(19) United States
(12) Patent Application Publication
(10) Pub. No.: US 2009/0054107 A1
(43) Pub. Date: Feb. 26, 2009

(54) HANDHELD COMMUNICATION DEVICE AND METHOD FOR CONFERENCE CALL INITIATION

(75) Inventors: John Morgan Feland, III, San Jose, CA (US); Thuy Thanh Bich Le, Santa Clara, CA (US)

Correspondence Address: INGRASSIA FISHER & LORENZ, P.C. (SYNA), 7010 E. Cochise Road, SCOTTSDALE, AZ, 85253, US

(73) Assignee: SYNAPTICS INCORPORATED, Santa Clara, CA (US)

(21) Appl. No.: 11/841,499

(22) Filed: Aug. 20, 2007

(51) Int. Cl. H04B 1/38; G06F 3/041

(52) U.S. Cl. 455/564; 345/173

(57) ABSTRACT

A handheld communication device and method is provided that facilitates improved device usability. The handheld communication device and method uses a touch screen interface, where the touch screen comprises a proximity sensor adapted to detect object motion in a sensing region, a display screen overlapping the sensing region, and a processor. The touch screen is adapted to provide user interface functionality on the communication device by facilitating the display of user interface elements and the selection and activation of corresponding functions. The handheld communication device and method are configured to display representations of calls on the display screen, and are further configured to initiate conference calls responsive to sensed object motion beginning at a first call representation and continuing toward a second call representation. Thus, a user can initiate a conference call with a relatively simple and easy to perform gesture on the touch screen.

### FIELD OF THE INVENTION

This invention generally relates to handheld communication devices, and more specifically relates to touch screens and using touch screens in handheld communication devices.

### BACKGROUND OF THE INVENTION

Communication devices continue to grow in popularity and importance. A wide variety of different types of handheld communication devices are available, including mobile phones, personal digital assistants (PDAs), as well as many multifunction or combination devices. The competition for customers and users in the handheld communication device market is intense, and there is a strong need for improvement in the performance of these communication devices. One important factor in the market success of communication devices is the user interface. A communication device with an easy to understand and use interface offers definite advantages over those that do not.

One issue in the design of handheld communication device user interfaces is facilitating the performance of complex tasks on the device. As one example, initiating a conference call with a handheld communication device can be very tedious, typically requiring many different actions to be performed on the part of the user before a conference call will be initiated. The difficultly in initiating a conference call can be a serious impediment to the functionality of the device, as many users will be unable or unwilling to perform the many tasks needed to initiate a conference call.

Thus, there exists a need for improvements in user interface of communication devices, and in particular for improvements in the usability of conference calls on handheld communication devices.

### BRIEF SUMMARY OF THE INVENTION

The embodiments of the present invention provide a handheld communication device and method that facilitates improved device usability. Specifically, the handheld communication device and method facilitates the initiation of conference calls using easy to perform actions on the device. The handheld communication device and method uses a touch screen interface, where the touch screen comprises a proximity sensor adapted to detect object motion in a sensing region, a display screen underlying the sensing region, and a processor. The touch screen is adapted to provide user interface functionality on the communication device by facilitating the display of user interface elements and the selection and activation of corresponding functions. In accordance with the embodiments of the invention, the handheld communication device and method are configured to display representations of calls on the display screen, and are further configured to initiate conference calls responsive to sensed object motion beginning at a first call representation and continuing toward a second call representation. Thus, a user can initiate a conference call with a relatively simple and easy to perform gesture on the touch screen. Thus, the handheld communication device and method provide improved user interface functionality.

### BRIEF DESCRIPTION OF DRAWINGS

The preferred exemplary embodiment of the present invention will hereinafter be described in conjunction with the appended drawings, where like designations denote like elements, and:

FIG. 1 is a block diagram of an handheld communication device that includes a proximity sensor device in accordance with an embodiment of the invention;

FIG. 2 is a flow diagram of a method for initiating a conference call in accordance with the embodiments of the invention; and

FIG. 3-9 are top views of a handheld communication device with a touch screen interface in accordance with an embodiment of the invention;

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

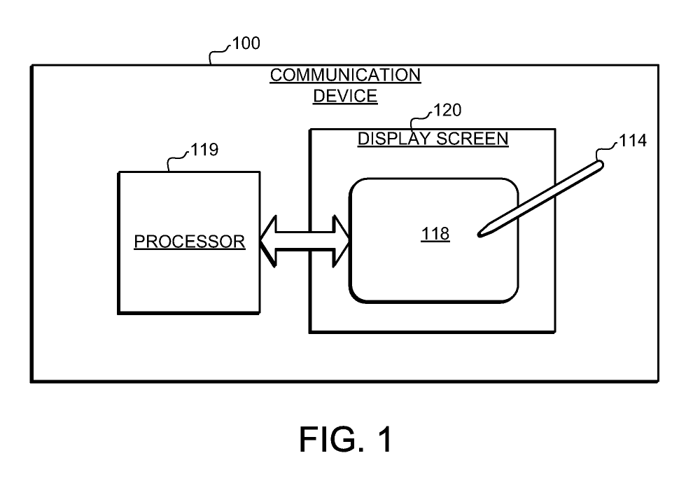

The embodiments of the present invention provide a handheld communication device and method that facilitates improved device usability. Specifically, the handheld communication device and method facilitates the initiation of conference calls using easy to perform actions. Turning now to the drawing figures, FIG. 1 is a block diagram of an exemplary handheld communication device 100 that operates with a display screen 120 and a proximity sensor device having a sensing region 118. Handheld communication device 100 is meant to represent any type of handheld communication device, including wireless phones and other wireless verbal/aural communication devices. For example, the device 100 can comprise mobile phones that use any suitable protocol, such as CDMA, TDMA, GSM and iDEN. Likewise, the handheld communication device 100 can comprise a device that provides voice communication over a wireless data network. For example, a device that provides voice-over-IP (VoIP) using Bluetooth, WiFi or any other suitable wireless network. Accordingly, the various embodiments of device 100 may include any suitable type of electronic components.

As will be discussed in greater detail below, the proximity sensor device having the sensing region 118 is configured with the display screen 120 as part of a touch screen interface for the handheld communication device 100. The proximity sensor device is sensitive to positional information, such as the position, of a stylus 114, finger and/or other input object within the sensing region 118. “Sensing region” 118 as used herein is intended to broadly encompass any space above, around, in and/or near the proximity sensor device wherein the sensor device is able to detect the object. In a conventional embodiment, sensing region 118 extends from the surface of the sensor in one or more directions for a distance into space until signal-to-noise ratios prevent object detection. This distance may be on the order of less than a millimeter, millimeters, centimeters, or more, and may vary significantly with the type of position sensing technology used and the accuracy desired. Other embodiments may require contact with the surface, either with or without applied pressure. Accordingly, the planarity, size, shape and exact locations of the particular sensing regions 118 will vary widely from embodiment to embodiment.

In operation, proximity sensor device suitably detects positional information, such as the position of stylus 114, a finger and/or other input object within sensing region 118. The proximity sensor device provides indicia of the positional information to portions of the handheld communication device 100. The processor 119 of the handheld communication device 100 appropriately processes the indicia to accept inputs from the user, to move a cursor or other object on a display, or for any other purpose.

The proximity sensor device includes a sensor (not shown) that utilizes any combination of sensing technology to implement the sensing region 118. The proximity sensor device can use a variety of techniques for detecting the presence of an object, and includes one or more electrodes or other structures adapted to detect object presence. As several non-limiting examples, the proximity sensor device can use capacitive, resistive, inductive, surface acoustic wave, or optical techniques. These techniques are advantageous to ones requiring moving mechanical structures (e.g. mechanical switches) that more easily wear out over time. In a common capacitive implementation of a touch sensor device a voltage is typically applied to create an electric field across a sensing surface. A capacitive proximity sensor device would then detect positional information about an object by detecting changes in capacitance caused by the changes in the electric field due to the object. Likewise, in a common resistive implementation, a flexible top layer and a rigid bottom layer are separated by insulating elements, and a voltage gradient is created across the layers. Pressing the flexible top layer creates electrical contact between the top layer and bottom layer. The resistive proximity sensor device would then detect positional information about the object by detecting the voltage output due to the relative resistances between driving electrodes at the point of contact of the object. In an inductive implementation, the sensor might pick up loop currents induced by a resonating coil or pair of coils, and use some combination of the magnitude, phase and/or frequency to determine positional information. In all of these cases the proximity sensor device detects the presence of the object and delivers indicia of the detected object to the device 100. For example, the sensor of proximity sensor device can use arrays of capacitive sensor electrodes to support any number of sensing regions 118. As another example, the sensor can use capacitive sensing technology in combination with resistive sensing technology to support the same sensing region 118 or different sensing regions 118. Examples of the type of technologies that can be used to implement the various embodiments of the invention can be found at U.S. Pat. No. 5,543,591, U.S. Pat. No. 6,259,234 and U.S. Pat. No. 5,815,091, each assigned to Synaptics Inc.

The processor 119 is coupled to the sensor of the proximity sensor device and the handheld communication device 100. In general, the processor 119 receives and processes electrical signals from sensor. The processor 119 can perform a variety of processes on the signals received from the sensor to implement the proximity sensor device. For example, the processor 119 can select or connect individual sensor electrodes, detect presence/proximity, calculate position or motion information, or interpret object motion as gestures. As additional examples, processor 119 can also report positional information constantly, when a threshold is reached, or in response some criterion such as an identified gesture. The processor 119 can report indications to other elements of the electronic system 100, or provide indications directly to one or more users. The processor 119 can also determine when certain types or combinations of object motions occur proximate the sensor. For example, the processor 119 can determine the presence and/or location of multiple objects in the sensing region, and can generate the appropriate indication(s) in response to those object presences. In some embodiments the processor 119 can also be adapted to perform other functions in the proximity sensor device.

In this specification, the term “processor” is defined to include one or more processing elements that are adapted to perform the recited operations. Thus, the processor 119 can comprise all or part of one or more integrated circuits, firmware code, and/or software code that receive electrical signals from the sensor, and communicate with other elements on the handheld communication device 100 as necessary.

Likewise, the positional information determined by the processor 119 can be any suitable indicia of object presence. For example, the processor 119 can be implemented to determine “zero-dimensional” 1-bit positional information (e.g. near/far or contact/no contact) or “one-dimensional” positional information as a scalar (e.g. position or motion along a sensing region). Processor 119 can also be implemented to determine multi-dimensional positional information as a combination of values (e.g. two-dimensional horizontal/vertical axes, three-dimensional horizontal/vertical/depth axes, angular/radial axes, or any other combination of axes that span multiple dimensions), and the like. Processor 119 can also be implemented to determine information about time or history.

Furthermore, the term “positional information” as used herein is intended to broadly encompass absolute and relative position-type information, and also other types of spatial-domain information such as velocity, acceleration, and the like, including measurement of motion in one or more directions. Various forms of positional information may also include time history components, as in the case of gesture recognition and the like. As will be described in greater detail below, the positional information from the processor 119 facilitates a full range of interface inputs, including use of the proximity sensor device as a pointing device for cursor control, selection, scrolling, dragging and other functions.

As stated above, in the embodiments of the present invention the proximity sensor device is adapted as part of a touch screen interface. Specifically, the sensing region 118 of the proximity sensor device overlaps at least a portion of the display screen 120. Together, the proximity sensor device and the display screen 120 provide a touch screen for interfacing with the handheld communication device 100. The display screen 120 can be any type of electronic display capable of displaying a visual interface to a user, and can include any type of LED (including organic LED (OLED)), CRT, LCD, plasma, EL or other display technology. When so implemented, the proximity sensor device can be used to activate functions on the handheld communication device 100. The proximity sensor device can allow a user to select a function by placing an object in the sensing region proximate an icon or other user interface element is associated with the function. Likewise, the proximity sensor device can be used to facilitate user interface interactions, such as button functions, scrolling, panning, menu navigation, cursor control, and the like. As another example, the proximity sensor device can be used to facilitate value adjustments, such as enabling changes to a device parameter. Device parameters can include visual parameters such as color, hue, brightness, and contrast, auditory parameters such as volume, pitch, and intensity, operation parameters such as speed and amplification. In these examples, the proximity sensor device is used to both activate the function and then to perform the adjustment, typically through the use of object motion in the sensing region.

It should also be understood that the different parts of the handheld communications device can share physical elements extensively. For example, some display and proximity sensing technologies can utilize the same electrical components for displaying and sensing. One implementation can use an optical sensor array embedded in the TFT structure of LCDs to enable optical proximity sensing through the top glass of the LCDs. Another implementation can use a resistive touch-sensitive mechanical switch into the pixel to enable both display and sensing to be performed by substantially the same structures.

In some embodiments, the handheld communication device 100 is implemented with the touch screen as the only user interface. In these embodiments, the handheld communication device 100 functionality is controlled exclusively through the touch screen. In other embodiments, the handheld communication device 100 includes other interface devices, such as mechanical buttons, switches, keypads and/or proximity sensor devices. Additionally, the handheld communication device 100 can include other display devices in addition to the touch screen, or additional touch screens.

It should also be understood that while the embodiments of the invention are to be described herein the context of a fully functioning handheld communication device, the mechanisms of the present invention are capable of being distributed as a program product in a variety of forms. For example, the mechanisms of the present invention can be implemented and distributed as a program on a computer-readable signal bearing media. Additionally, the embodiments of the present invention apply equally regardless of the particular type of computer-readable signal bearing media used to carry out the distribution. Examples of signal bearing media include: recordable media such as memory sticks/cards/modules and disk drives, which may use flash, optical, magnetic, holographic, or any other storage technology.

In accordance with the embodiments of the present invention, the handheld communication device 100 facilitates the initiation of conference calls using easy to perform actions on a touch screen interface, where the touch screen interface comprises the proximity sensor adapted to detect object motion in the sensing region 118, the display screen 120 overlapped by the sensing region 118, and the processor 119. The touch screen is configured to display representations of calls on the display screen, and the handheld communication device 100 is configured to initiate conference calls responsive to sensed object motion beginning at a first call representation and continuing toward a second call representation. Thus, a user can initiate a conference call on the handheld communication device 100 with a relatively simple and easy to perform gesture on the touch screen.

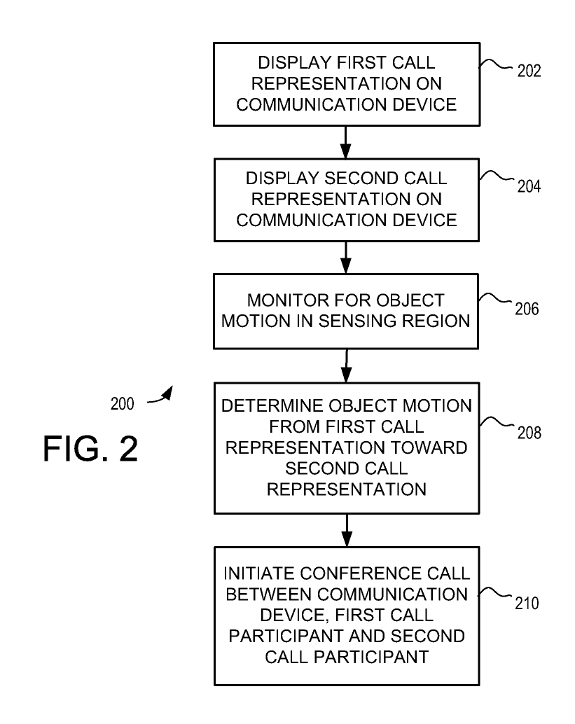

Turning now to FIG. 2, a method 200 of initiating a conference call on handheld communication device is illustrated. The method facilitates improved communication device usability by initiating a conference call in response to a relatively simple gesture on a touch screen. The first step 202 is to display a first call representation on the handheld communication device. The second step 204 is to display a second call representation on the handheld communication device. For steps 202 and 204, the call representations comprise display elements that correspond to other call participants, and thus represent other communication devices (e.g., stationary or mobile phones, videoconferencing systems, and enhanced PDAs), where each of the other communication devices can be associated with one or more entities (e.g., individuals, organizations, and businesses). The call representations are displayed on a touch screen, where the touch screen serves as the user interface for the handheld communication device. The call representations can include graphical elements indicative of entities associated with the communication devices, such as images of people and objects, icons or symbols. The call representations can also include textual elements such as names, numbers or other identifiers. Thus, the first call representation can include an image and name corresponding to a first call participant (such as that of the owner or regular user of the first call participant), and the second call representation can include an image and name corresponding to a second call participant (such as that of the owner or regular user of the second call participant).

Typically, the steps of displaying call representations could occur in response to a variety of different actions on the handheld communication device. For example, the call representations can be displayed when calls to the corresponding participants are currently active or on hold, are being made or received, or have just been started or completed. Likewise, call representations can be displayed when a user of the handheld communication device selects a directory or other listing of call representations associated with various possible call participants. In any of these cases, the handheld communication device displays the call representations as appropriate on the device.

The next step 206 is to monitor for object motion in the sensing region. Again, the touch screen can comprise any type of suitable proximity sensing device, using any type of suitable sensing technology. Typically, the step of monitoring for object presence would be performed continuously, with the proximity sensor device continuously monitoring for object motion whenever the touch screen on the communication device is enabled.

The next step 208 is to determine the presence of object motion beginning from the first call representation and continuing toward the second call representation. When an object moves in the sensing region, the proximity sensor device is able to detect that motion and determine positional information that is indicative of the object's position and/or motion in the sensing region. The determined positional information can indicate to the communication device when an object has been moved in the sensing region, with motion beginning at the first call representation and continuing toward the second call representation.

It should be noted that step 208 can be implemented in a variety of different ways. Specifically, the handheld communication device can be implemented with varying amounts of spatial and temporal tolerance for determining when motion begins at the first call representation and continues toward the second call representation. For example, motion can be interpreted to begin at the first call representation when it is first sensed by the proximity sensor device as within a defined region around the call representation; alternatively, motion can be interpreted to begin at the first call representation as long as it crosses that defined region around the first call representation. Likewise, motion can be interpreted to begin at the first call representation when the object appears near the first call representation following a statically or dynamically specified time period where no objects or no object motion was sensed anywhere in the sensing region; in contrast, motion can be interpreted to begin at the first call representation when the object appears near the first call representation following a statically or dynamically specified time period where a particular type of object motion was sensed in the sensing region (e.g. an earlier tap in a defined region around the first call representation.). Furthermore, motion can be interpreted to begin at the first call representation if the object is sensed to be substantially stationary near the first call representation for a statically or dynamically defined time duration, regardless of previous locations or motions of the object in the sensing region. Any combination of these and other criteria can be combined to implement step 208. Similarly, motion in the direction of the second call representation can be interpreted to continue toward the second call representation if the initial or average object motion would lead the object to the second call representation, only when the object motion has progressed to within a specified distance of the second call representation, or any combination thereof. Further criteria, such as maximum time limits and timeouts, can also be used.

In variations on these embodiments, the handheld communications device can be implemented to require an additional action to confirm the conference call before the conference call will be initiated. For example, in addition to determining the presence of object motion from the first call representation to the second call representation, the device can be implemented to require that the object also retreat from the sensing region before the conference call is initiated. Thus, the initiation of the conference call would be responsive to the occurrence of both the object motion in the sensing region and the retreat of the object from the sensing region thereafter. Other gestures can likewise be used to confirm the initiation of the conference call. For example, the communication device can be implemented to require the performance of one or more input gestures (e.g., tap gesture) or other object contacts to the device following the object motion before the conference call will be initiated. These gestures and/or contacts can be required to be in designated regions of the communications device in some embodiments, or anywhere detectable by the communications device in other embodiments. These gestures and/or contacts can be used to confirm the initiation of the conference call. In various embodiments these gestures can be performed by the same object providing the object motion toward the second call representation, while in other embodiments a different object is used. Likewise, the use of voice commands, or another input device such as a button, or contact anywhere on handheld communication device designated for such confirmation, can be used to confirm before the conference call will be initiated.

Returning to method 200, when object motion from the first call representation toward the second call representation is determined, the next step 210 is to initiate a conference call among the communication device, the first call participant, and the second call participant. The initiation of the conference call can be performed in several different ways. The techniques used to initiate the conference call will typically depend on a variety of factors, including the type of communication device, the service provider, the type of call participants, and the network communication protocols used, to name several examples. In one embodiment, the handheld communication device sends appropriate signals to the service provider that instructs the service provider to initiate the conference call. In this embodiment the structure and format of the signals would depend upon requirements of the service provider and its communication network protocols.

In an alternative embodiment, the handheld communication device initiates the conference call by itself combining call data received from the first call participant with call data received from the second call participant. In this embodiment, the call data from the first participant can be received on one wireless data stream, with the call data from a second participant received on a second wireless data stream. The handheld communication devices combines the call data, and the combined call data is transmitted to both the first and second call participants, thus effectuating the conference call. Again, the techniques used for combining call data and transmitting the combined data to the call participants would depend upon the requirements of the network and its associated communication protocols.

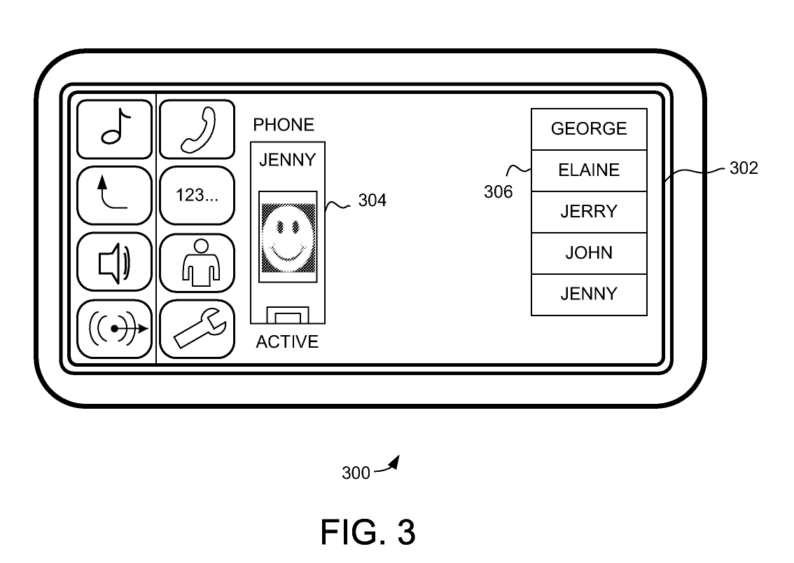

Likewise, the handheld communication device can be implemented to either initiate the conference call from a combination of existing calls (including calls established and active or on hold), or to initiate the conference call by creating one or more new calls and combining the calls in a conference call. Turning now to FIGS. 3-8, an exemplary handheld communication device 300 is illustrated. The exemplary handheld communication device 300 is a multifunction device that includes both communication and media player capabilities. The device 300 includes a touch screen 302 that provides a user interface. The touch screen 302 comprises a proximity sensor adapted to detect object presences in a sensing region, and a display screen having at least a portion overlapped by the sensing region. Again, the technology used to implement the proximity sensor can be any suitable sensing technology, including the capacitive and resistive technologies discussed above. Likewise, the technology used to implement the display screen can be any suitable display technology, including the LCD and EL technologies discussed above. Again, it should be noted that the device 300 is merely exemplary of the type of communication devices in which the system and method can be implemented.

Illustrated on the touch screen 302 in FIG. 3 is a plurality of user interface elements. These user interface elements include a variety of visual elements used to implement specific functions. These functions include both phone functions and media player functions. The phone functions include keyboard, address book, and tools functions. The media player functions include an up directory function, a volume function, and a send function. The user interface can also suitably include other navigation elements, such as virtual dials, wheels, sliders, and scroll bars. Again, these user interface elements are merely exemplary of the types of functions that can be implemented and the corresponding types of elements that can be displayed. Naturally, the type of user interface elements would depend on the specific functions being implemented on the device.

In the illustrated embodiment, the touch screen 302 also includes call representations. As described above, call representations comprise display elements that correspond to other call participants, and thus can represent other communication devices, where each of the other communication devices can be associated with a person, group or entity. In FIG. 3, a first exemplary call representation 304 corresponding to a call participant labeled “Jenny” is illustrated as displayed on touch screen 302. This call representation 304 includes both a name and an image associated with the call participant. Additionally, this call representation 304 identifies the status of the call as being currently active.

Also included on the touch screen is a listing or directory 306 of other call representations. These call representations correspond to call participants that could be called and/or joined into a conference call with the currently active call. Each of these call representations includes a name associated with the call participant, but does not include an image or other graphical data. As shown in FIG. 3, the names shown for the call participants are of individuals who regularly use those associated call participants.

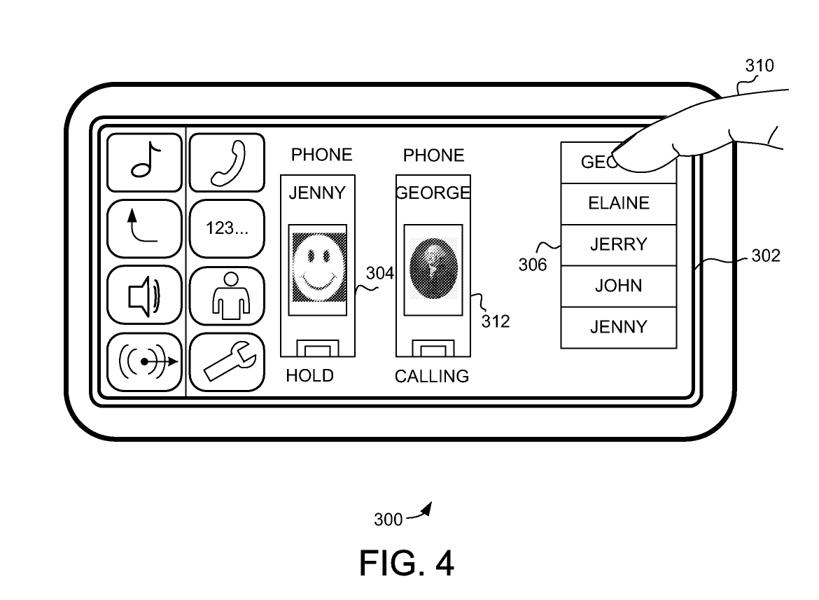

Turning now to FIG. 4, the handheld communications device 300 is illustrated with a first finger 310 placed in the sensing region over the “George” call representation in directory 306. As the proximity sensor is configured to determine positional information for objects in the sensing region, the handheld communication device 300 identifies the “George” call representation as being selected. It should be noted that while fingers are illustrated in this exemplary embodiment as being used to select the call representation, the touch screen 302 would often be implemented to respond to a variety of different objects, including pointing devices such as styli and pens. Similarly, handheld communications device 300 can be implemented to require more than simple placement to trigger selection. More complex gestures (e.g. single or multiple taps, finger strokes following particular paths, and gestures with various time requirements) may be required. In addition or as an alternate criterion, the handheld communications device 300 may need to be in particular modes or have particular software applications enabled for selection to occur.

In response to the selection of the “George” call representation in directory 306, the handheld communication device 300 puts “Jenny” on hold and initiates a call to the call participant associated with “George”. This is displayed to the user by the addition of a second, separate “George” call representation 312 outside of directory 306, which has a status indicated as “calling”.

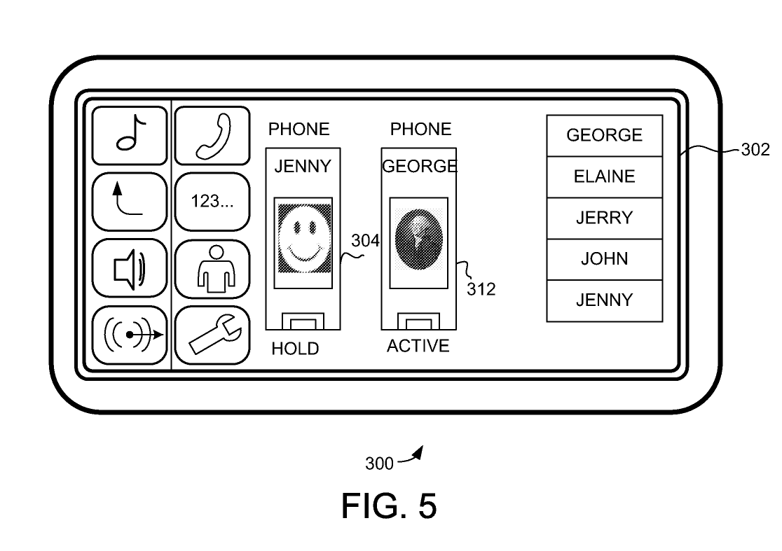

Turning now to FIG. 5, the device 300 is illustrated with the call representation 312 indicating that the call to “George” is active, and the call representation 304 indicating that the call to “Jenny” is on hold.

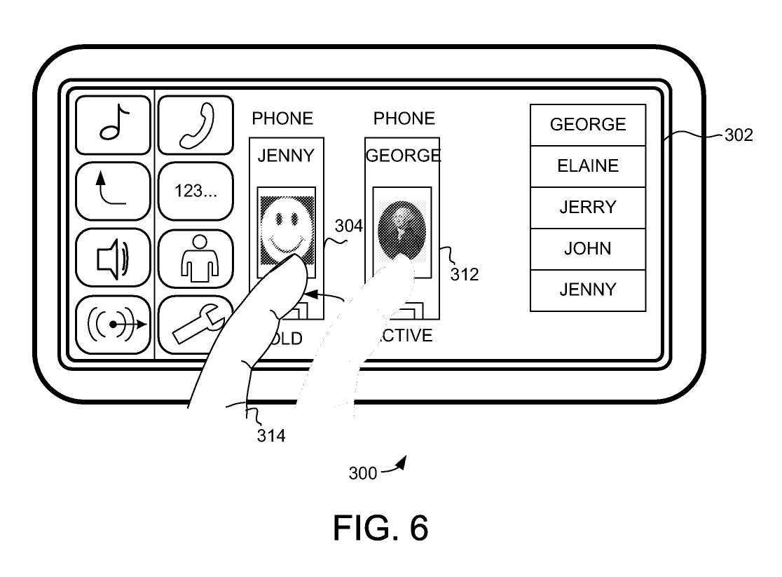

In accordance with the embodiments of the present invention, a conference call can be initiated using easy to perform actions on the touch screen 302. Specifically, the touch screen 302 is configured to initiate conference calls responsive to sensed object motion beginning at a first call representation and continuing toward a second call representation. Turning now to FIG. 6, the device 300 is illustrated with motion of a finger 314 beginning at a first call representation 312 (“George”) and continuing toward a second call representation 304 (“Jenny”). The touch screen 302 is configured sense this motion and, responsive to this sensed motion, initiate a conference call between device 300, the first call participant “George” and a second call participant “Jenny”. Thus, a user can initiate a conference call on the handheld communication device 300 with a relatively simple and easy to perform gesture on the touch screen.

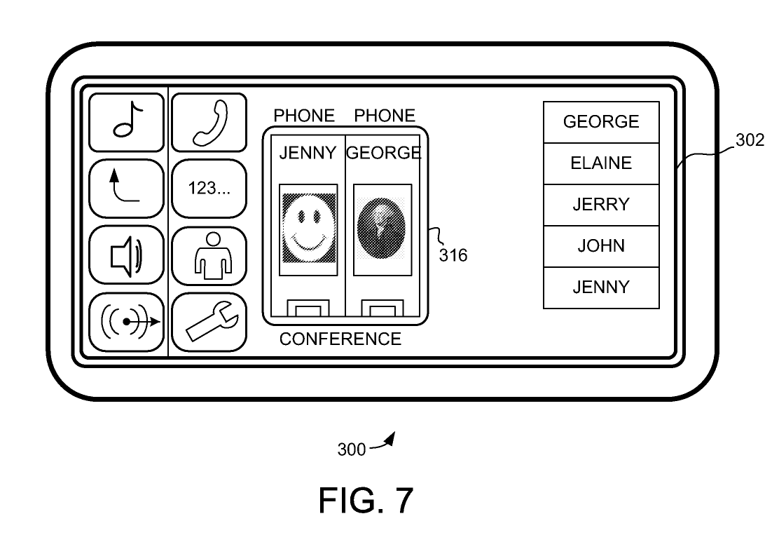

Turning now to FIG. 7, the device 300 is illustrated with a visual representation of the created conference call displayed on the touch screen 302. In this case, a unified border 316 around the two call representations and the label of “conference” indicates to a user that the conference all as been created. Of course, these are just two examples of the types of visual representations of a created conference call that can be displayed on the touch screen 302.

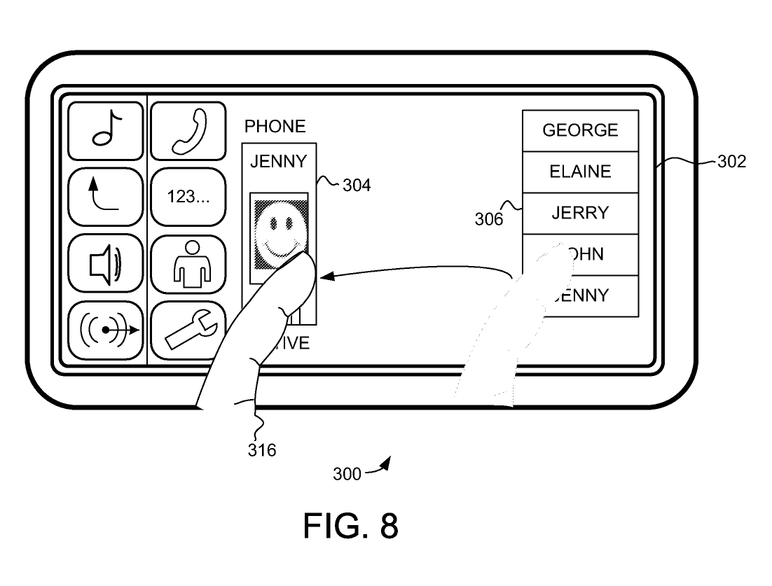

It should be noted that in this example the conference call was initiated between two existing calls, i.e., the active call to “George” and the on-hold call to “Jenny”. In other embodiments, conference calls can be initiated without the two calls having been previously created. Turning now to FIG. 8, the device 300 is illustrated with motion of a finger 316 beginning at directory 306, at a first call representation for “John”, and continuing toward the second call representation 304 for “Jenny”. Again, the touch screen 302 is configured sense this motion and, responsive to this sensed motion, initiate a conference call between device 300, the first call participant “John” and the second call participant “Jenny”.

In this case, as there is no preexisting call with John, the communication device 300 is configured to first create a call to the call participant “John” before combining “John”, “Jenny” and the device 300 into the conference call. Thus, in this embodiment a user can initiate a conference call directly with a relatively simple and easy to perform gesture on the touch screen, and without requiring two previously existing calls.

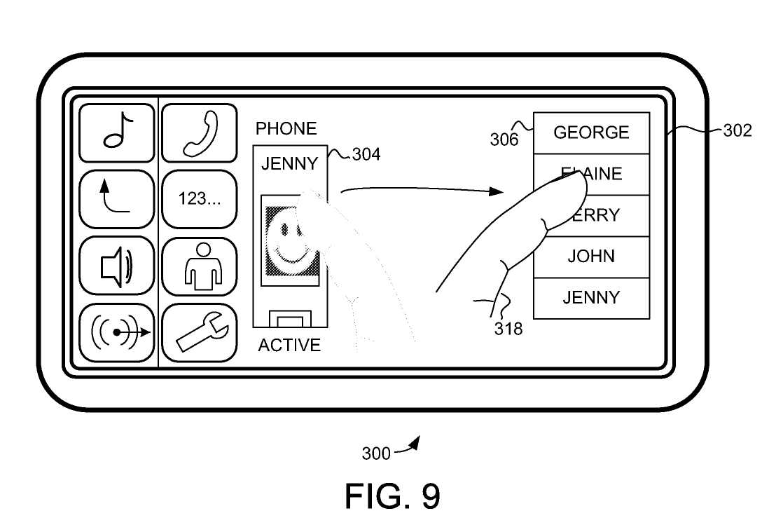

Turning now to FIG. 9, the device 300 is illustrated with another variation on this embodiment. In FIG. 9, the motion of a finger 318 begins at the call representation for “Jenny” and continues toward the call representation for “Elaine” in directory 306. Again, the touch screen 302 is configured sense this motion and, responsive to this sensed motion, initiate a conference call between device 300, the call participant “Jenny” and the call participant “Elaine”. This embodiment shows how the device 300 can be implemented to initiate the conference call regardless of the direction of motion between the call participants. This makes initiating the conference call exceptionally easy for the user. Furthermore, the conference call is again initiated without requiring two previously existing calls.

In addition to displaying the call representations themselves, the touch sensor 300 can also be configured to indicate to a user that motion is being sensed between the call representations by creating a visual “dragging” trail from the first call representation toward the second as or shortly after the motion occurs. This type of visual feedback can help the user perform the motion correctly, and thus can also improve the usability of the device.

The embodiments of the present invention thus provide a handheld communication device and method that facilitates improved device usability. The handheld communication device and method uses a touch screen interface, where the touch screen comprises a proximity sensor adapted to detect object motion in a sensing region, a display screen overlapping the sensing region, and a processor. The touch screen is adapted to provide user interface functionality on the communication device by facilitating the display of user interface elements and the selection and activation of corresponding functions. The handheld communication device and method are configured to display representations of calls on the display screen, and are further configured to initiate conference calls responsive to sensed object motion beginning at a first call representation and continuing toward a second call representation. Thus, a user can initiate a conference call with a relatively simple and easy to perform gesture on the touch screen.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

What is claimed is:

1. A handheld communication device having a touch screen interface, the handheld communication device comprising:
a display screen, the display screen configured to display at least a first call representation and a second call representation, the first call representation corresponding to a first call participant, the second call representation corresponding to a second call participant;
a sensor proximate to the display screen, the sensor adapted to sense object motion in a sensing region, wherein the sensing region overlaps at least part of the display screen; and
a processor, the processor coupled to the sensor, the processor configured to:
responsive to sensed object motion in the sensing region beginning at the first call representation and continuing toward the second call representation, initiate a conference call among the handheld communication device, the first call participant, and the second call participant.

2. The handheld communication device of claim 1 wherein the first call representation includes one of a name and an image of a first person associated with the first call participant, and wherein the second call representation includes an image of a second person associated with the second call participant.

3. The handheld communication device of claim 1 wherein the display screen is configured to display a visual representation of the conference call responsive to the initiation of the conference call among the handheld communication device, the first call participant, and the second call participant.

4. The handheld communication device of claim 3 wherein the visual representation of the conference call comprises a unified border around the first call representation and the second call representation.

5. The handheld communication device of claim 1 wherein the first call representation includes a name of a first person, and wherein the second call representation includes a name of a second person.

6. The handheld communication device of claim 1 wherein the processor is configured to initiate the conference call by sending a signal to a service provider that instructs the service provider to commence the conference call.

7. The handheld communication device of claim 1 wherein the processor is adapted to initiate the conference call by combining first call data from the first call participant received over a first wireless data stream with second call data from the second call participant received over a second wireless data stream.

8. The handheld communication device of claim 1 wherein the conference call is initiated by putting the first call participant on hold, calling the second call participant, and joining the first call participant and the second call participant into conference with the handheld communication device.

9. The handheld communication device of claim 1 wherein the conference call is initiated by joining an existing call with the first call participant and an existing call with the second call participant into the conference call.

10. The handheld communication device of claim 1 wherein the handheld communication device comprises a mobile phone.

11. The handheld communication device of claim 1 wherein the processor is configured to initiate the conference call by initiating the conference call after the sensed object motion has progressed to within a specified distance of the second call representation.

12. The handheld communication device of claim 1 wherein the processor is configured to initiate the conference call by initiating the conference call responsive to an object moving from the first call representation toward the second call representation and retreating from the sensing region thereafter.

13. The handheld communication device of claim 1 wherein the processor is configured to initiate the conference call by initiating the conference call responsive to an object moving from the first call representation toward the second call representation and performing an input gesture thereafter.

14. The handheld communication device of claim 13 wherein the input gesture comprises a tap gesture.

15. The handheld communication device of claim 1 wherein the processor is configured to initiate the conference by initiating the conference call responsive to a first object moving from the first call representation toward the second call representation and a second object performing an input gesture while the first object is still in the sensing region.

16. A touch screen interface for a mobile phone, the touch screen interface comprising:
a display screen, the display screen configured to display at least a first call representation and a second call representation, the first call representation corresponding to a first call participant and including one of a name and a first image of a first person, the second call representation corresponding to a second call participant and including a second image of a second person;
a sensor proximate to the display screen, the sensor adapted to sense object motion in a sensing region, wherein the sensing region overlaps at least part of the display screen; and
a processor, the processor coupled to the sensor, the processor configured to:
responsive to object motion in the sensing region beginning at the first call representation and continuing toward the second call representation, initiate a conference call among the handheld communication device, the first call participant, and the second call participant by sending a signal to a service provider that instructs the service provider to initiate the conference call; and
responsive to the initiation of the conference call, generate a visual representation of the initiation of the conference call on the display.

17. A method for establishing a conference call using a touch screen in a handheld communication device, the method comprising:
displaying on the touch screen at least a first call representation and a second call representation, the first call representation corresponding to a first call participant, the second call representation corresponding to a second call participant;
monitoring for object motion in a sensing region provided by the touch screen;
responsive to object motion in the sensing region beginning at the first graphical call representation and continuing toward the second graphical call representation, initiating a conference call among the handheld communication device, the first call participant, and the second call participant.

18. The method of claim 17 wherein the first call representation includes one of a name and an image of a first person, and wherein the second call representation includes an image of a second person.

19. The method of claim 17 further comprising the step of displaying a visual representation of the conference call responsive to the initiation of the conference call among the handheld communication device, the first call participant, and the second call participant.

20. The method of claim 19 wherein the visual representation of the conference call comprises a unified border around the first call representation and the second call representation.

21. The method of claim 17 wherein the first call representation further includes a name of a first person, and wherein the second call representation further includes a name of a second person.

22. The method of claim 17 wherein the step of initiating a conference call among the handheld communication device, the first call participant, and the second call participant comprises sending a signal to a service provider that instructs the service provider to commence the conference call.

23. The method of claim 17 wherein the step of initiating a conference call among the handheld communication device, the first call participant, and the second call participant comprises combining first call data from the first call participant received over a first wireless data stream with second call data from the second call participant received over a second wireless data stream.

24. The method of claim 17 wherein the step of initiating a conference call among the handheld communication device, the first call participant, and the second call participant comprises putting the first call participant on hold, calling the second call participant, and joining the first call participant and the second call participant into conference with the handheld communication device.

25. The method of claim 17 wherein the step of initiating a conference call among the handheld communication device, the first call participant, and the second call participant comprises joining an existing call with the first call participant and an existing call with the second call participant into the conference call.

26. The method of claim 17 wherein the handheld communication device comprises a mobile phone with media player capabilities.

27. The method of claim 17 wherein the step of initiating a conference call among the handheld communication device, the first call participant, and the second call participant comprises initiating the conference call after the sensed object motion has progressed to within a specified distance of the second call representation.

28. The method of claim 17 wherein the step of initiating a conference call among the handheld communication device, the first call participant, and the second call participant comprises initiating the conference call responsive to an object moving from the first call representation toward the second call representation and retreating from the sensing region thereafter.

29. The method of claim 17 wherein the step of initiating a conference call among the handheld communication device, the first call participant, and the second call participant comprises initiating the conference call responsive to an object moving from the first call representation toward the second call representation and performing an input gesture thereafter.

30. The method of claim 29 wherein the input gesture comprises a tap gesture.

31. The method of claim 17 wherein the step of initiating a conference call among the handheld communication device, the first call participant, and the second call participant comprises initiating the conference call responsive to a first object moving from the first call representation toward the second call representation and a second object contacting a designated part of the handheld communication device while the first object is still in the sensing region.

32. A program product comprising:
a) a sensor program, the sensor program adapted to;
display on a touch screen at least a first call representation and a second call representation, the first call representation corresponding to a first call participant, the second call representation corresponding to a second call participant; and
responsive to object motion in a touch screen sensing region beginning at the first call representation and continuing toward the second call representation, initiate a conference call among the handheld communication device, the first call participant, and the second call participant; and
b) computer-readable media bearing said sensor program.
